(19) United States
(12) Patent Application Publication
(10) Pub. No.: US 2016/0249670 A1
(43) Pub. Date: Sep. 1, 2016

(54) INHIBITION OF MICROBIAL AND CELLULAR GROWTH IN SUBSTANCES

(71) Applicant: THE UNIVERSITY OF BIRMINGHAM, Birmingham, West Midlands (GB)

(72) Inventors: Narinder SINGH BAINES, Birmingham, West Midlands (GB); Gary Anthony LEEKE, Birmingham, West Midlands (GB)

(21) Appl. No.: 15/028,189

(22) PCT Filed: Oct. 7, 2014
(86) PCT No.: PCT/GB2014/053020

§ 371 Date: Apr. 8, 2016

(30) Foreign Application Priority Data
Oct. 9, 2013 (GB) 1317864.5

(51) Int. Cl. A23L 3/30; C12H 1/16; A23C 3/07

(52) U.S. Cl. CPC A23L 3/30; A23C 3/073; C12H 1/165; A23V 2002/00

(57) ABSTRACT

The invention provides a method of treating a food, beverage or cosmetic to inhibit microbial or cellular growth, comprising subjecting the substance to low frequency ultrasound under elevated gas pressure at between 10 and 100 bar, more typically 20 and 500 bar. Also provided is an apparatus for treating a substance which is a food, beverage or cosmetic to inhibit microbial or cellular growth in the food, beverage or cosmetic comprising: (i) a substance inlet (ii) a pressurisation zone, the pressurisation zone comprising a pressurising gas inlet and low frequency ultrasonic generator; and (iii) a depressurisation zone.

The invention relates to methods and apparatus for inhibiting microbial and cellular growth in substances such as powders and liquids, food and beverages, using low frequency ultrasound at elevated pressures.

There are a number of treatments available to reduce the viability of bacteria in dairy and beverage streams (e.g. high temperature short time pasteurisation (HTST), ultra high temperature treatment (UHT), centrifugation/bactofugation, reduction in pH, microwave, UV, ultrasonic, thermosonication and high pressure). These are typically used in combination, (except HTST and UHT), to reduce viability of spoilage and pathogenic bacteria to acceptable limits in the final product. The processes require high energy inputs or require additional downstream separation processes to remove organic or mineral acids used to coagulate the casein (i.e. pH treatment). Rapid decompression treatment has also been reported in the literature [1-3] but this is only suitable for bacteria that contain gas vacuoles, therefore is not broadly applicable for food processing.

All these treatment routes are not suitable to reduce and stabilise the bacteria content in some process streams found in the diary (and beverage and brewing) industries. For example, bactofuge desludge (BFDS), a milk by-product, cannot be treated by these routes due to formation of a highly viscous solid under elevated temperature and is currently disposed at high cost to the processor. The current invention allows a step change in the processing of bactofuge desludge as it reduces the bacteria content (aerobic and lactic acid bacteria) to fresh milk levels and causes separation of the curd from the whey fraction without the additional of traditional chemicals. The curd fraction can be used as a food product e.g. cheese) or animal feed or be used to raise energy by digestion. The whey fraction has value in its own right as a potential source of bioactive peptides. The current invention can therefore also be seen as a dewatering process of the solid curd fraction. In addition to liquid samples, the technology can also be applied to dry powdered samples (e.g. dry powdered malts) by operating the process in a mode similar to a fluidised bed.

EP 2,572,592 describes high frequency sonication using several frequencies above 30 kHz (30 kHz to 5 MHz) before or during decompression using most typically nitrogen as the compressing gas. Typically an ultraviolet light is used to assist sterilisation in combination with photocatalysts. Such complex devices are stated to be used for periods longer than a minute to sterilise substances.

Such a system is complex and requires large amounts of energy to use the high frequency sonicators referred to in the document and the complex system of turbulence sterilisers and ultraviolet sources.

US 2009246073 also directs to use 100 kHz to 2 MHz ultrasound. The application states that below 1 MHz does not kill microbes but dislodges them from the surface of food so is not recommended.

The inventors have unexpectedly found that using 10 to 40 kHz and especially 20 to 30 kHz with elevated gas pressure of 10 to 150 bar, typically 20 to 100 bar, kills microbes, such as aerobic and lactic acid bacteria in a very short period of time, typically less than 30 seconds.

The invention provides a method of treating a substance to inhibit microbial or cellular growth, comprising subjecting the substance to low frequency ultrasound under elevated gas pressure at between 10 and 150 bar, more typically 20 to 100 bar.

The substance may be a liquid or a fluidised powder, especially a substantially dry powder, such as a food stuff, beverage or cosmetic. Liquids include milk, beer, lager, fruit juices, milk bactofuge desludge and starch slurries. Powders include, for example, powdered malts. The substance may also be wastes from food or other processing which are treated prior to discharge. Approximately 130 billion litres of beer are produced annually and over 600 million tonnes of cow milk annually.

Typically the low frequency ultrasound is 10 to 40 kHz, more typically 20 to 30 kHz. Air, nitrogen, carbon dioxide or a mixture of carbon dioxide and nitrogen may be used to elevate the pressure. Typically carbon dioxide is used as the pressurising gas as this has been found to be especially effective due to, it is believed, the production of carbonic acid. Typically the pressuring gas contains >50%, >60%, >70%, >80%, >90% or 100% v/v of carbon dioxide. The use of carbon dioxide makes the technique especially useful for liquids with a pH of 6 or less.

Sonication may be applied in pulse mode.

Typically the substance is treated for less than 30 minutes, less than 10 minutes, less than 1 minute, typically less than 50 seconds, less than 40 seconds, or less than 30 seconds with the ultrasound. Typically it is treated for at least 5 seconds or at least 15 seconds. The pressurisation may be for substantially the same amount of time, before depressurising, for example, to ambient pressure. Alternatively the pressure may be maintained for a period of time after sonication.

Typically in flow operation 15 seconds to 10 minutes, especially less than 30 seconds. In batch operation typically less than 30 minutes or less than 60 seconds is used.

Typically the treatment with pressure and ultrasound occurs if less than 50° C., less than 30° C., ambient temperature (20° C.) or below 20° C., below 10° C. or below 5° C.

On depressurising it has been found that many liquids comprise precipitate from bacteria or proteins in the liquid which may be separated. For example, the method allows the removal of curds from whey which may be then processed further. Methods of separating include using filters or centrifuges.

The microbial and cellular growth may be bacterial, fungal (such as yeast) or indeed eukaryotic cell growth.

The invention also provides an apparatus for treating a substance to inhibiting microbial or cellular growth in the substance comprising:

(i) a substance inlet

(ii) a pressurisation zone, the pressurisation zone comprising a pressurising gas inlet and low frequency ultrasonic generator; and

(iii) a depressurisation zone.

The ultrasonic generator may be adapted to generate ultrasound at 10 to 40 kHz or 20 to 30 kHz. The pressurising gas supplied to the apparatus and pressures may be as defined above.

Typically the intensity of the ultrasound waves is 5 to 230 W/cm². Typically less than 20 W/cm² for flow processing or less than 200 W/cm² for batch processing.

The depressurisation zone may comprise a solids separator. Gas released by depressurisation may be recycled, optionally after scrubbing to remove unwanted gases such as water vapour or other materials.

Where the substance is a powder, the apparatus may comprise a fluidised bed. Hence the substance may be charged through a vertical flow chamber where it is fluidised with the pressurisation gas. During fluidisation the powder may be subjected to sonication with the ultrasound.

The apparatus may comprise a controller adapted to control one or more of:

(i) the flow of substance through the apparatus

(ii) the pressure of the substance in the apparatus and/or

(iii) the low frequency ultrasound generator.

The apparatus may be used to treat the substance in a batch or in a flow of material through the apparatus.

The invention will now be described by way of examples with reference to the following examples:

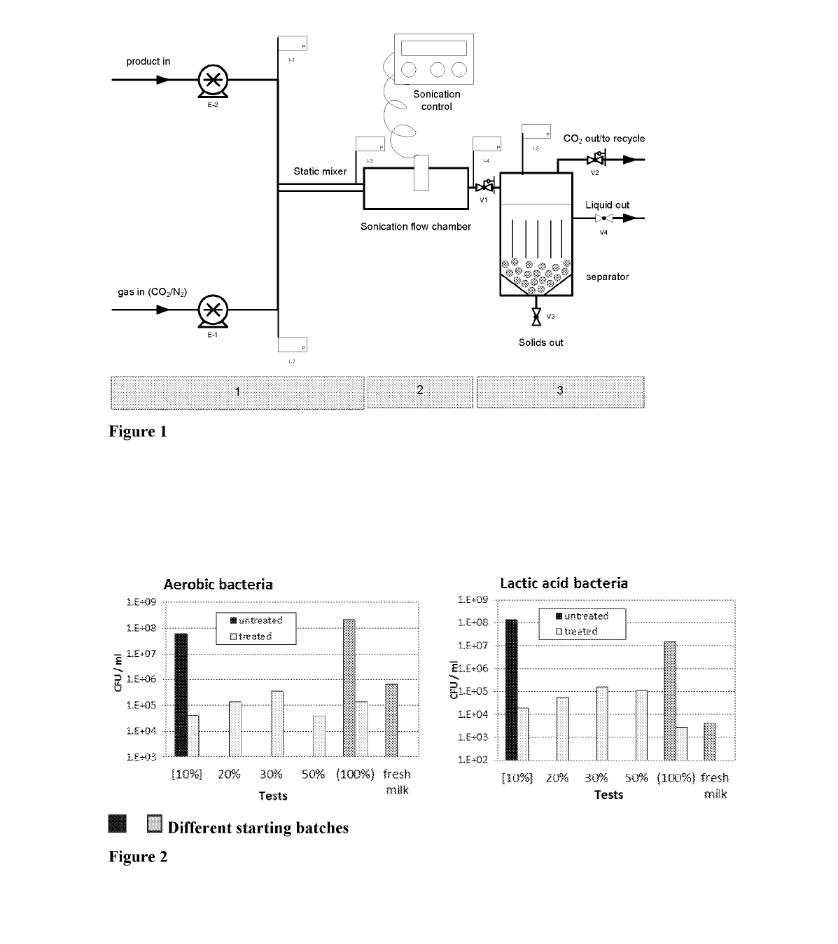

FIG. 1 The elevated pressure sonication (EPS) flow process for liquid samples. Zone 1 is for delivery and contact; Zone 2 is for sonic treatment and pressurisation; Zone 3 is for depressurisation and recovery.

FIG. 2 Effect of sonication power of bactofuge desludge viable cell count at different percentages of ultrasound power. 100%-1500 W; power given in parenthesis. Tests undertaken at 50° C., 100 bar for 60 min in CO₂.

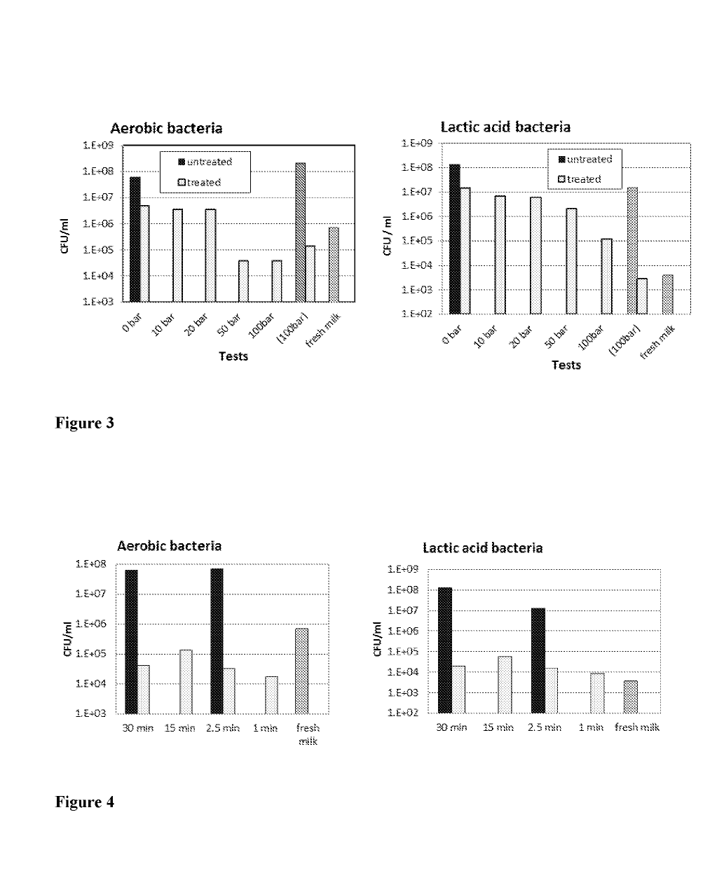

FIG. 3 Effect of sonication on bactofuge desludge viable cell count at different pressures. Tests undertaken at 50° C., 50% power for 60 min in CO₂.

FIG. 4 Effect of sonication time on bactofuge desludge viable cell count. Tests undertaken at 50° C., 20% power at different sonication times in CO₂.

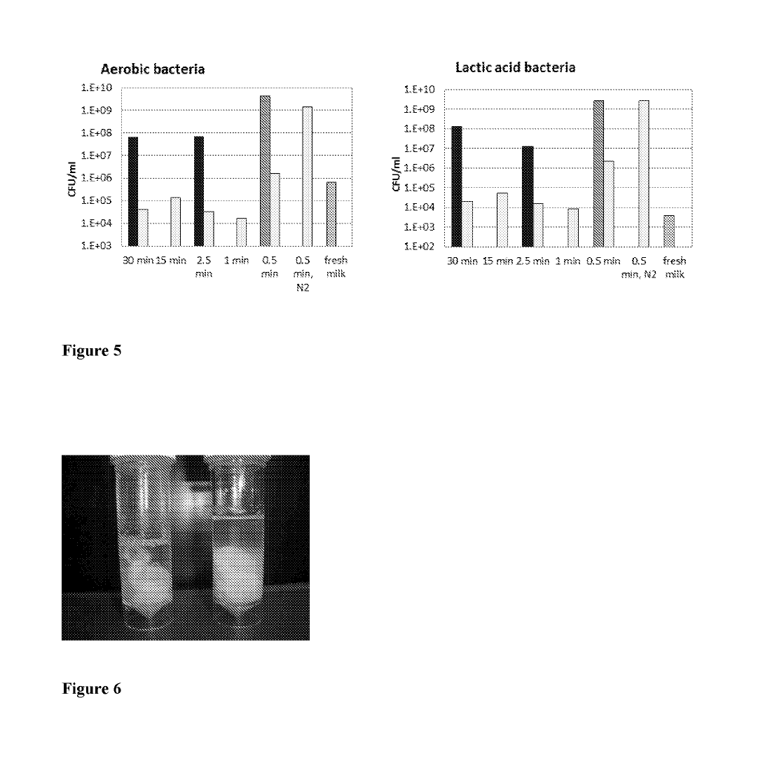

FIG. 5 Effect of sonication time of bactofuge desludge viable cell count. Tests undertaken at 50° C., 100 bar, 20% power at different sonication times in the presence of CO₂. or N₂.

FIG. 6 Images of bactofuge desludge post high pressure sonication treatment.

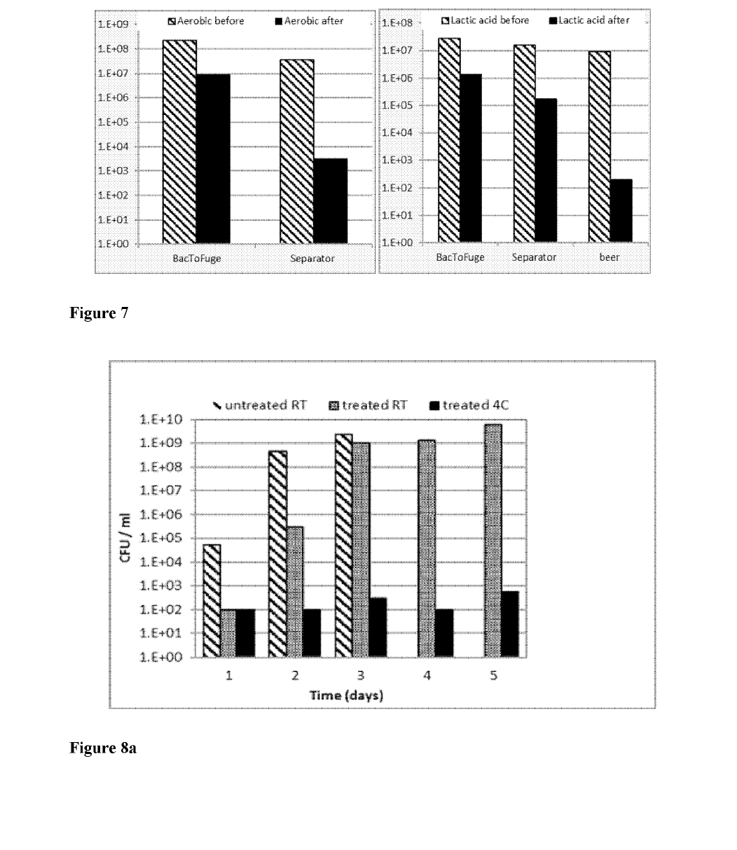

FIG. 7 show batch test results for aerobic bacteria and lactic acid bacteria on beer and desludge samples (y axes are in CFU/ml).

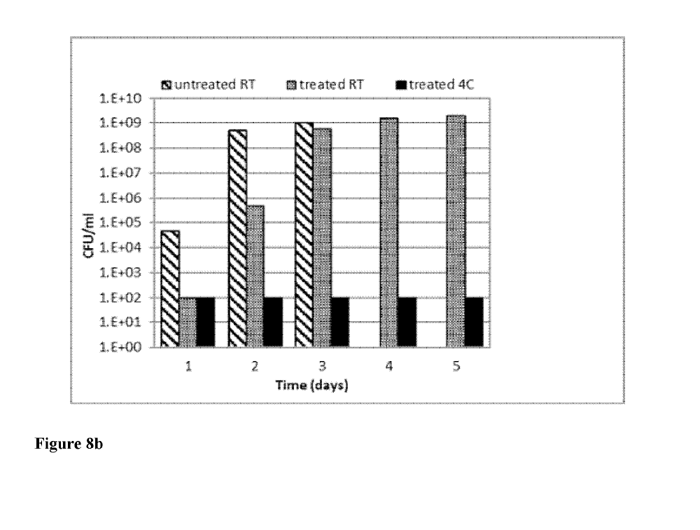

FIG. 8a shows shelf-life data for aerobic bacteria.

FIG. 8b shows shelf-life data for lactic acid bacteria.

### EQUIPMENT DESCRIPTION

1) Product/gas contact.

A pump and a compressor are needed to convey the product and gas streams into the static mixer. The residence time in the mixer may provide sufficient contact between the two streams and will be directly interfaced with the sonication chamber to avoid precipitation of the solids. The mixer and process lines are made from stainless steel; (carbon or other steel alloys may also be used). Pressure monitoring devices will be fitted as indicated.

2) Sonication chamber

The chamber is a stainless steel tube (typically approx volume 10 litres) containing the sonication equipment where the bacteria are killed. The conditions in the chamber will be typically up to 100 bar and requires no heat input. The sonication is applied in pulse mode.

3) Separator

The treated product enters the separator (approximately 100 litres volume) where it is separated. The separator contains weir plates to separate the liquid and to alleviate the re-flotation of the solid fraction. A level gauge may provide information on liquid height and removed as necessary using valve V4. The height of the solid fraction may be monitored by an optical sensor and removed as necessary through the automated rotary valve (V3). Valves V1 and V2 maintain the desired pressures within the sonication chamber and separator. Both the sonication chamber and separator may be fitted with pressure devices and relief valves.

The equipment can be retrofitted and integrated into the end-user(s) existing remote control systems.

Test Data

Bactofuge Desludge

A low frequency sonication (20 kHz) was used in combination with gases at elevated pressures to investigate their effect on the viable cell count (aerobic and lactic acid bacteria) in bactofuge desludge. A series of tests were undertaken at the conditions reported in Table 2 above and the results are shown in FIGS. 2 to 5.

TABLE 2
Experimental conditions for high pressure sonication experiments.

| | Pressure | Sonication | Process Time |
|---|---|---|---|
| Gas | (bar) | Power (%) | (min) |
| CO₂ or N₂ | Ambient, 10, | 10, 20, 30, | 0.5, 1, 2.5, |
| | 20, 50, 100 | 50, 100 | 15, 30, 60 |

Note:
100% power = 1500 W at 20 kHz

Effect of Ultrasound Power on Viable Cell Count

It can be seen in FIG. 2 that the sonication power percentage can be reduced to 10% and a 3 to 3.5 log reduction in viable cell count can be obtained. The levels of viable bacteria are below that found in fresh pasteurised milk (acquired from a shop). The variations in cell counts for 20% and 30% (aerobes) and 20%, 30% and 50% for lactic acid bacteria compared to 100% and 10% are due to the differences in lapsed time to undertake the cell viability tests after high pressure sonication treatment. Viable cell counts for samples at 20, 30 and 50% were undertaken at 2 and 3 days post processing, and therefore demonstrate the effectiveness of the combined treatment to stabilise cell count levels.

Effect of Pressure on Viable Cell Count

In light of the results shown in FIG. 2, tests were undertaken at lower pressure in order to reduce the pressure design requirements for the treatment process. FIG. 3 shows that a pressure greater than 50 bar is required to achieve a 3.5 log fold reduction in aerobic viable cell count levels, whereas a pressure greater than 100 bar is required to achieve a 3.5 log fold reduction in lactic acid viable cell count levels. Again, the variation in lactic acid cell count at 100 bar was due to the time elapsed before conducting the bacteria viability tests.

In the absence of any gas pressure (i.e. 0 bar, ambient pressure conditions) sonication has a small affect on viable cell count with approximately 1 log-fold reduction. A combination of CO₂ and sonication is therefore necessary

Effect of Time on Viable Cell Count

The effect of sonication time was investigated in order to reduce the energy requirement of the treatment process. The results in FIG. 4 show that the time can be reduced to 1 min with 3 log-fold reductions in viable cell counts still being achieved. This short time makes the combined high pressure sonication treatment process suitable for flow processing of BFDS.

The sonication time was reduced to 0.5 minute (with all other conditions the same) and showed favourable results toward cell death (see FIG. 5). Tests were also undertaken in the presence of N₂ at 100 bar. The results in FIG. 5 show that N₂ had an insignificant effect on cell mortality.

Processed Bactofuge Desludge

Images of the bactofuge desludge post high pressure sonication treatment is shown in FIG. 6 below (both samples have undergone treatment). Due to the low temperature, the low frequency of the sonication and power input the solid fraction did not form a latex-like material and exhibited the ability to flow (further transport property data are required). During exposure to high pressure CO₂ the pH would have been reduced to approx. 3 at the process conditions. The literature reports that when sonication is combined with a low pH environment organisms are not able to grow [4, 5]. However, the pH reduction (in combination with sonication) has never been reported by the use of CO₂ and is achieved by the addition of solid chemicals. The low pH caused the bactofuge desludge to separate into whey and solid fractions. Prior to treatment the COD of the bactofuge desludge was 1.2 million (making it costly to dispose). After high pressure sonication treatment the COD of the whey fraction was 33 k to 42 k with the remainder in the solid fraction. The treatment does not lower the COD but partitions it into the solid fraction. This offers an added advantageous separation process and retains the majority of the COD in a dewatered solid fraction making it suitable for use a value added product (e.g. food, energy source). The whey fraction also contains valuable components.

Energy Requirements for the High Pressure Sonication Treatment

Table 1 below shows the energy requirements (kJ/L) to treat 700 mL of bactofuge desludge using high pressure sonication. A comparison is made with the energy required to pasteurise milk using HTST treatment (without heat integration). It can be seen that high pressure sonication (HPS) requires 40 times less energy that required to pasteurise milk and is therefore highly attractive as a commercial process.

TABLE 1
Energy requirement to treat 700 mL bactofuge
desludge at different conditions.

| | | | | Sonication | Energy |
|---|---|---|---|---|---|
| | P | T | Ultrasound | Time | Needed |
| Test | (bar) | (° C.) | Power (%) | (min) | (kJ/L) |
| HPS28 | 100 | 50 | 100 | 15 | 854 |
| HPS31 | 50 | 50 | 50 | 30 | 701 |
| HPS34 | 100 | 50 | 50 | 30 | 1241 |
| HPS36 | 100 | 50 | 20 | 15 | 171 |
| HPS38 | 100 | 50 | 20 | 2.5 | 34 |
| HPS39 | 100 | 50 | 20 | 1 | 10 |
| HPS40 | 100 | 50 | 20 | 0.5 | 5 |
| Pasteurisation | (continuous) | 72 | | 0.25 | 196 |
| of milk by | (batch) | 63 | | 15 | 158 |
| HTST | (high fat) | 75 | | 0.25 | 209 |

HTST = High Temperature Short Time. All tests gave a 3 to 3.5 log fold reduction in aerobic bacteria. All tests, except HPS31 gave a 3 to 3.5 log fold reduction in lactic acid bacteria

### BEER TESTS—EXAMPLE 1

Bottles of beer were spiked with L. Plantarum broth to give CFU/ml=9.4×10⁶, then processed under 100 bar, 20% power at 20° C., the CFU drop to 2.0×10². A fall of 4.5 log. Analysis by flow cytometry (CYTO9-PI) gave the following:

Before processing: 90.1% of cells were alive cells and 9.2% were dead cells After processing: 0.5% of cells were alive and 99.0% were dead cells This gives 99.45% kill rate.

Temperatures lower than 20° C. are being investigated. A temperature of 8 ° C. is being targeted as this is the temperature at which most lagers are brewed. The majority of bottled beers are flash pasteurised (a minority are cold filtered), which means that the beer is heated from 8 to 72° C. then cooled requiring energy. If pasteurisation takes place at low temperature a huge energy saving will result. There is approximately 130 billion litres of beer produced annually.

### BEER TESTS—EXAMPLE 2

Batch tests were carried out using beer (lager) and desludge (bactofuge and separator) samples. Both desludge and beer were processed at 100 bar using 20% of 1500 W US power and 1:1 on-off pulse for 60 seconds, however desludges were treated at 50° C. (similar to the temperature at which desludge is generated by the milk processing line) and beer at room temperature (≈25° C.; closer to the beer processing temperature, which is <5° C.).

Beer was spiked with lactic acid bacteria (Lactobacilli plantarum), while for desludge naturally present lactic acid and aerobic bacteria numbers were monitored. Table 3 and FIG. 7 show that for the desludge, the kill rate of aerobic bacteria is better than lactic acid bacteria. A 4.5 log fold decrease was obtained for the beer sample undertaken in batch conditions. This indicates that low viscosity samples respond better to the process conditions.

TABLE 3
Batch US tests results on milk by-product and beer samples

| | | Total aerobic CFU/ml | | Total lactic acid CFU/ml | |
|---|---|---|---|---|---|
| | | (Nutrient agar) | | (MRS agar, candle jar) | |
| | | before | after | before | after |
| 2 | BactoFuge | 2.3E+08 | 8.4E+06 | 2.9E+07 | 1.4E+06 |
| 3 | Separator | 3.6E+07 | 3.2E+03 | 1.6E+07 | 1.7E+05 |
| 4 | Beer | | | 9.4E+06 | 2.0E+02 |

Flow cytometry was also used to determine bacterial viability in the spiked beer samples.

TABLE 4
Flow Cytometry results for beer spiked with L. plantarum

| | |
|---|---|
| Live cell (%) | Dead cell (%) |

| | Before | After | Before | After |
|---|---|---|---|---|
| Sample | Processing | Processing | Processing | Processing |
| 1-B | 98.8 | 0.5 | 0.1 | 99.0 |

Continuous Flow Tests on Beer

Tests were undertaken in a flow apparatus at much less than 10 ml/min flow rate with a US energy input of around 7 J/mL. Tests were processed at 100 bar, 25 C at 25% of 130 W US input. Before testing the L. plantarum count was 4.6×107 CFU/ml and after testing this was reduced to 1.3×102 CFU/mL. The reduction in viable cells is very similar to that of the batch testing.

A test at higher power of 36 J/ml at 100 bar, 25 C, US power of 25% of 130 W, at around 5 ml/min gave similar kill rates. Initially the count was 8.4×105 CFU/mL which decreased to less than 1000 CFU/mL after testing.

Tests on Other Bacteria Spiked in Beer Samples

L. brevis, L. lindneri, L. buchneri were added to beer samples and the effect of the elevate pressure US process on cell death was assessed. Together with L. plantarum these are the four most commonly found lactic bacteria in beer. Tests on L. plantarum showed the success of the US process, but in comparison to desludge samples a higher power input is needed. Tests were undertaken at higher power (100 bar, 25° C., 10 ml/min feed flow and around 30 J/ml US power input) and 4 to 5 log reductions were achieved.

Continuous Flow Tests on Desludge

Tests were taken on separator desludge in a flow apparatus at 10 ml/min at around 50 C, 100 bar, using US power of 25% amplitude of 130 W to give an energy input of 11.5 kJ/L. The viable cell counts are shown below in Table 5.

TABLE 5

| | |
|---|---|
| Total aerobic count | Lactic acid bacteria |
| (CFU/ml) | (CFU/ml) |

| Test | Before | After | Before | After |
|---|---|---|---|---|
| Separator | 6.3 × 10⁸ | 2.0 × 10³ | 1.3 × 10⁸ | 2.0 × 10³ |

Further tests were undertaken as flows:

TABLE 6
Conditions for 50:50 fresh desludge samples (<3
hours from sample taking) treated under continuous flow

| | Sample | ultrasound | | |
|---|---|---|---|---|
| | flow | Pulse | Energy | |
| Test | (ml/min) | (on:off) | (J/ml) | notes |
| 1 | 5 | no pulse | 36.1 | Fresh 50:50 Bactofuge + Separator |
| | | | | using the highest energy |
| 2 | 10 | no pulse | 18.0 | Fresh 50:50 Bactofuge + Separator |
| | | | | using high energy |
| 3 | 10 | 2:1 | 10.1 | Fresh 50:50 Bactofuge + Separator |
| | | | | using the optimum batch condition |

(T = 50° C., P = 100 bar, sample age = 0 day; Ultrasound: Ampl. = 25%)

The cell counts for the tests shown in Table 7

TABLE 7
Bacteria count analysis before and after
treatment for tests shown in Table 6

| | Total aerobic (CFU/ml) | | Lactic acid bacteria (CFU/ml) | |
|---|---|---|---|---|
| | Before | After | Before | After |
| 1 | <1 × 10⁶ | 1.1 × 10⁵ | <1 × 10⁶ | 4.6 × 10⁴ |
| 2 | <1 × 10⁶ | 6.0 × 10³ | <1 × 10⁶ | 1.0 × 10⁴ |
| 3 | <1.0 × 10⁶ | 7.0 × 10³ | 7.5 × 10⁴ | 2.0 × 10³ |

Shelf-Life of Treated and Untreated Bactofuge

The shelf-life was tested at room temperature (RT) and 4° C. The untreated RT sample solidified on the 4th day and so only 3 days are shown for this sample in FIGS. 8a and 8b. The results show that after high pressure US treatment (100 bar, 50 C, 25% power) shows that a much reduced cell count is obtained for the first 2 days at RT. The process therefore stabilises the product allowing transportation.

[1]. John W. Foster, J. W., Cowan, R. M. and Ted A. Maag, T. A., Rupture of bacteria by explosive decompression, J Bacteriol., 1962, 83(2): 330-334

[2]. Fraser, D., Bursting bacteria by release of gas pressure. Nature. 1951, 167(4236):33-34.

[3]. Hemmingsen, B. B., and E A Hemmingsen, E. A., Rupture of the cell envelope by induced intracellular gas phase expansion in gas vacuolate bacteria. J Bacteriol., 1980, 143(2): 841-846

[4]. Daniela Bermúdez-Aguirre and Gustavo V. Barbosa-Cánovas, Ultrasound Technologies for Food and Bioprocessing, Food Engineering Series, 2011, 445-465, DOI: 10.1007/978-1-4419-7472-3_16, Springer

[5]. http://www.dairyconsultant.co.uk/si-milkpasteurisation.php

1. A method of treating a food, beverage or cosmetic to inhibit microbial or cellular growth, comprising subjecting the substance to low frequency ultrasound under elevated gas pressure at between 10 and 100 bar, more typically 20 and 500 bar.

2. A method according to claim 1, wherein the substance is a liquid or fluidised powder.

3. A method according to claim 1, wherein the frequency of the low frequency ultrasound is 10 to 40 kHz, typically 20 to 20 kHz.

4. A method according to claim 1, wherein the substance is beer, lager, fruit juice, milk, bactofuge desludge or a starch slurry.

5. A method according to claim 1, wherein the substance is a liquid and comprising the steps of removing solid material from the liquid after treatment with the low frequency ultrasound.

6. A method according to claim 5, wherein the substance is milk or milk bactofuge desludge and the solids are curds.

7. A method according to claim 1, wherein the substance is pressurised with nitrogen, carbon dioxide or a mixture thereof.

8. A method according to claim 7, wherein the substance is pressurised with carbon dioxide.

9. A method according to claim 1, wherein the substance is treated with the low frequency ultrasound for less than 1 minute.

10. A method according to claim 1, wherein the power of the low frequency ultrasound has an intensity of between 5 and 230 W/cm².

11. A method according to claim 1, wherein the substance is treated with the low frequency ultrasound at below 30° C.

12. A method according to claim 1, wherein the substance is depressurised after applying the low frequency ultrasound.

13. An apparatus for treating a substance which is a food, beverage or cosmetic to inhibit microbial or cellular growth in the food, beverage or cosmetic comprising:
(i) a substance inlet;
(ii) a pressurisation zone, the pressurisation zone comprising a pressurising gas inlet and low frequency ultrasonic generator; and
(iii) a depressurisation zone.

14. An apparatus according to claim 13, wherein the substance is a liquid and the depressurisation zone comprises a solids separator.

15. An apparatus according to claim 13, wherein the substance is a powder and the pressurisation zone comprises a fluidised bed.

16. An apparatus according to claim 13, wherein the low frequency ultrasonic generator is adapted to generate ultrasound at 10 to 40 kHz.

17. An apparatus according to claim 13, wherein the pressurisation zone is adapted to pressurise the substance to between 10 and 150 bar, preferably 20 and 100 bar.

18. An apparatus according to claim 13, wherein the pressurising gas, nitrogen, carbon dioxide or a mixture thereof, most preferably carbon dioxide is in contact with a liquid or solid.

19. An apparatus according to claim 13, comprising a controller adapted to control one or more of:
(i) the flow of the substance through the apparatus
(ii) the residence time of the substance in the apparatus
(iii) the temperature of the substance in the apparatus
(iv) the pressure of the substance in the apparatus
(v) the low frequency ultrasound generator.
